(19) United States
(12) Patent Application Publication
(10) Pub. No.: US 2026/0250436 A1
(43) Pub. Date: Aug. 27, 2026

(54) PROCESS AND APPARATUS FOR THE PREPARATION OF HIGHLY REACTIVE POLYISOBUTYLENE

(71) Applicant: Hindustan Petroleum Corporation Limited, Karnataka (IN)

(72) Inventors: Monikangkana TALUKDAR, Karnataka (IN); Laxmi, Karnataka (IN); Ujjal HALDAR, Karnataka (IN); Yogesh Popatrao PATIL, Karnataka (IN); Bennet CHELLIAHN, Karnataka (IN); Srinivasa Narasimha SHESHACHALA, Karnataka (IN)

(21) Appl. No.: 19/550,297

(22) Filed: Feb. 26, 2026

(30) Foreign Application Priority Data
Feb. 26, 2025 (IN) 202541016954

(51) Int. Cl. C08F 110/10; C08F 2/06; C08F 4/52; C08F 6/00; C08F 6/02; C08F 6/08

(52) U.S. Cl. CPC C08F 110/10; C08F 2/06; C08F 4/52; C08F 6/001; C08F 6/02; C08F 6/08; C08F 2410/01

(57) ABSTRACT

The present invention relates to a process and an apparatus for the preparation of highly reactive polyisobutylene (HR-PIB) having wide range of industrial applications across different sectors. The highly reactive polyisobutylene (HR-PIB) obtained from the process of the present invention has a number average molecular weight in the range of 500-5000 and an exo-content of at least 80 mole %.

### FIELD OF THE INVENTION

The present invention relates to the field of isobutylene polymerization. More specifically, the present invention relates to a process for the preparation of highly reactive polyisobutylene (HR-PIB). The present invention also relates to an apparatus for the preparation of highly reactive polyisobutylene (HR-PIB).

### BACKGROUND OF THE INVENTION

Highly reactive polyisobutylene (HRPIB) is a specialized form of polyisobutylene that has enhanced reactivity compared to standard polyisobutylene. This increased reactivity opens up a range of industrial applications across different sectors:

Lube Industry: HR-PIB plays a significant role in the lubrication industry due to its unique properties. It is often used as a viscosity index improver, foam controller, improved dispersity or enhanced resistance to sludge formation, etc.

Adhesives and Sealants: HR-PIB is often used in the formulation of adhesives and sealants due to its ability to form strong bonds with various substrates.

Automotive Industry: In the automotive sector, HR-PIB can be used in the manufacture of gaskets, seals, and other components that require high performance under extreme conditions. Its reactivity and adhesive properties make it suitable for ensuring durable and reliable seals.

Coatings: The chemical properties of HR-PIB make it suitable for use in high-performance coatings.

Rubber Products: HR-PIB is utilized in the production of high-performance rubber products. Its reactivity enhances the cross-linking process during rubber synthesis, resulting in products with improved elasticity, durability, and resistance to environmental factors.

U.S. Pat. No. 7,411,104B2 discloses a method for the production of HR-PIB 300\tilde{ } 5000 (Mₙ) by using inexpensive catalyst. The catalyst used is a secondary alkylether, a tertiary alcohol and boron trifluoride. The secondary alkylether comprises diisopropylether, di(sec-butyl) ether, di(sec-hexyl) ether and/or di(sec-octyl) ether. The tertiary alcohol comprises t-butylalcohol, 4-hydroxy-4-methyl-2-pentanone and/or 2-methyl-2-butanol. The mole ratio of the co-catalysts (the secondary alkylether and tertiary alcohol) to the boron trifluoride is 1.0-2.0:1. The mole ratio of secondary alkylether to tertiary alcohol 0.5:1.2. The catalyst further comprises solvent(s) selected from chloromethane, dichloromethane and/or chloroform. Polybutene is produced at −50 to +20° C. The boron trifluoride is used in an amount of 0.05-1.0 weight parts per 100 weight parts of isobutene raw material.

U.S. Pat. No. 9,862,784B2 discloses a process for the production of HR-PIB, especially focusing on improvement in conventional inefficient complex preparation system. A complex catalyst preparing apparatus is provided for mixing high-activity complex catalyst having a low molar ratio and low-activity complex catalyst having a high molar ratio to form HR-PIB with 10% increased content of vinylidene while ensuring efficient production with less production cost.

U.S. Pat. No. 10,059,786B2 discloses an apparatus that enables selective-preparation of HR-PIB (>70%), medium-reactive polybutene (40-70%) and non-reactive polybutene (<40%) in single plant, by economical process. The process includes: (a) a reactive polybutene polymerization catalyst feeder 2, (b) a non-reactive polybutene polymerization catalyst feeder 1, and (c) a reactor 3. The reactive polybutene polymerization catalyst supplied through catalyst feeder 2 is a Lewis acid boron trifluoride, boron trichloride, aluminum trichloride, and zinc chloride). The non-reactive polybutene polymerization Lewis acid catalyst (aluminum trichloride, zinc chloride, iron chloride) mixed with low molecular polybutene supplied through feeder 1 to produce a non-reactive polybutene polymerization catalyst in the slurry form. Co-catalyst mentioned herein (alkyl ether, alcoholates, or water).

However, the prior arts disclose various process and apparatus for the preparation of polyisobutylene. But there is still a requirement of cost-effective process and apparatus for the production of highly reactive polyisobutylene (HRPIB) to meet the industrial requirements.

### OBJECTIVES OF THE INVENTION

The main objective of the present invention is to provide a process for the preparation of a highly reactive polyisobutylene (HR-PIB).

Another objective of the present invention is to provide an apparatus for the preparation of the highly reactive polyisobutylene (HR-PIB).

### SUMMARY OF THE INVENTION

This summary is provided to introduce a selection of concepts, in a simplified format, that are further described in the detailed description of the invention. This summary is neither intended to identify key or essential inventive concepts of the invention and nor is it intended to determine the scope of the invention.

The present invention provides a process for preparing a highly reactive polyisobutylene (HRPIB), the process comprising routing a Lewis acid [1] and a Lewis base [2] in a weight percentage ratio of 1:0.8-2.5 in a catalyst premix reactor [3] for preparing a homogeneous catalyst complex [4] routing the homogeneous catalyst complex [4], a C4 raffinate feed [6] and a solvent [5] in a polymerization reactor [7] for a polymerization reaction to obtain a mixture [8] comprising the highly reactive polyisobutylene (HR-PIB), unconverted C4 monomers, water, C8 oligomers, C12-C16 oligomers and a residual catalyst; routing the mixture [8] to a high pressure distillation column [9] for removing unconverted C4 monomers from the mixture [8] to obtain a bottom product comprising the highly reactive polyisobutylene (HR-PIB), water, C8 oligomers, C12-C16 oligomers and the residual catalyst; routing out the unconverted C4 monomers from top of the high pressure distillation column [9] followed by recycling the unconverted C4 monomers back to a naphtha cracker; routing the bottom product to a neutralization tank for quenching the residual catalyst in a basic media by adding a polymerization quencher routed to the neutralization tank from a polymerization quench tank to obtain a neutralized effluent comprising a catalyst salt, and a product; routing the neutralized effluent to a decanter for removing water from the neutralized effluent to obtain an aqueous effluent [17] comprising the catalyst salt, and an organic effluent comprising C8 oligomers, C12-C16 oligomers, and the highly reactive polyisobutylene (HR-PIB); routing the aqueous effluent to an aqueous tank to remove the catalyst salt; routing the organic effluent to a divided wall distillation (DWD) column [20] for removing the C8 oligomers and the C12-C16 oligomers from the organic effluent to obtain the highly reactive polyisobutylene (HR-PIB) [23]; and optionally routing the organic effluent to a second distillation column and a third distillation column arranged in a sequence for removing the C8 oligomers [21] through atmospheric high-pressure distillation and the C12-C16 oligomers through vacuum high-pressure distillation, respectively from the organic effluent [19] to obtain the highly reactive polyisobutylene (HR-PIB) [23].

The present invention also provides an apparatus for preparing a highly reactive polyisobutylene (HR-PIB), the apparatus comprising a plug flow reactor (PFR) [3] for preparing a homogenous catalyst complex [4]; a polymerization reactor [7] connected to the plug flow reactor [3] to receive the homogenous catalyst complex [4], along with a C4 raffinate feed [6] and a solvent [5] for a polymerization reaction to provide a mixture [8]; a high pressure distillation column [9] connected to the polymerization reactor [7] to receive the mixture [8] from the polymerization reactor [7] for removing unconverted C4 monomers from the mixture [8] to obtain a bottom product [11], wherein the unconverted C4 monomers is routed out from top of the high pressure distillation column [9] and recycled back to a naphtha cracker; a neutralization tank connected to the high pressure distillation column [9] to receive the bottom product from the bottom of the high pressure distillation column [9] for neutralizing the residual catalyst in the bottom product with a polymerization quencher to obtain a neutralized effluent comprising a catalyst salt, water, C8 oligomers, C12-C16 oligomers, and a highly reactive polyisobutylene (HR-PIB); a polymerization quench tank connected to the neutralization tank for supplying the polymerization quencher [14] to the neutralization tank [12]; a decanter connected to the neutralization tank to receive the neutralized effluent to remove water from the neutralized effluent to obtain an aqueous effluents comprising the catalyst salt, and an organic effluent comprising C8 oligomers, C12-C16 oligomers, and the highly reactive polyisobutylene (HR-PIB); an aqueous tank connected to the decanter to receive the aqueous effluents [17]; and a divided wall distillation (DWD) column connected to the decanter to receive the organic effluent from the decanter for the removal of C8 oligomers and C12-C16 oligomers from the organic effluent to obtain the highly reactive polyisobutylene (HR-PIB) [23].

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates schematic diagram of the apparatus for preparing a highly reactive polyisobutylene (HR-PIB) with a divided wall distillation (DWD) column as per an embodiment of the present invention.

FIG. 2 illustrates chemical structure of ethyl aluminium sesquichloride (EASC).

FIG. 3 illustrates 1H NMR spectrum of the highly reactive polyisobutylene (HR-PIB) recorded in CDCl₃ (the peak at 4.86 and 5.08 corresponding to reactive vinylidene units) and prepared as per the process for preparing a highly reactive polyisobutylene (HR-PIB) of the present invention.

### DETAILED DESCRIPTION OF THE INVENTION

For the purpose of promoting an understanding of the principles of the invention, reference will now be made to the embodiments in the specific language to describe the same. It will nevertheless be understood that no limitation of the scope of the invention is thereby intended, such alterations and further modifications in the illustrated process, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The composition, methods, and examples provided herein are illustrative only and not intended to be limiting.

The articles “a”, “an” and “the” are used to refer to one or to more than one (i.e., to at least one) of the grammatical object of the article.

The term “some” as used herein is defined as “none, or one, or more than one, or all”. Accordingly, the terms “none”, “one”, “more than one”, “more than one, but not all” or “all” would all fall under the definition of “some”. The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments”.

More specifically, any terms used herein such as but not limited to “includes”, “comprises”, “has”, “consists” and grammatical variants thereof is inclusive or open-ended and does not exclude additional, unrecited elements or method steps. The specification will be understood to also include embodiments which have the transitional phrase “consisting of” or “consisting essentially of” in place of the transitional phrase “comprising”. The transitional phrase “consisting of” excludes any element, step, or ingredient not specified in the claim, except for impurities associated therewith. The transitional phrase “consisting essentially of” limits the scope of a claim to the specified materials or steps “and those that do not materially affect the basic and novel characteristic(s)” of the claimed invention.

Whether or not a certain feature or element was limited to being used only once, either way it may still be referred to as “one or more features” or “one or more elements” or “at least one feature” or “at least one element”. Furthermore, the use of the terms “one or more” or “at least one” feature or element do NOT preclude there being none of that feature or element, unless otherwise specified by limiting language such as “there NEEDS to be one or more” or “one or more element is REQUIRED”.

Use of the phrases and/or terms such as but not limited to “a first embodiment”, “a further embodiment”, “an alternate embodiment”, “one embodiment”, “an embodiment”, “multiple embodiments”, “some embodiments”, “other embodiments”, “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

As used herein, the term “about” is used to indicate a range or approximation that allows for slight variations or deviations from a specific value or parameter without departing from the scope of the present invention. When “about” is used in conjunction with numerical values, it signifies that the disclosed value or parameter may vary by +10%, preferably +5%, of the indicated values.

The terminology and structure employed herein is for describing, teaching, and illuminating some embodiments and their specific features and elements and does not limit, restrict, or reduce the spirit and scope of the invention.

The present invention discloses a process for the polymerization of isobutylene (IB) typically involves contacting the C4 raffinate containing isobutylene (IB) (not less than 30%) with catalyst complex comprising a Lewis acid and Lewis base complex at −40 to 10° C. at atmospheric pressure to obtain the highly reactive polyisobutylene (HR-PIB) containing exo-olefin content of at least 80 mol %.

In an aspect of the present invention, the conversion of C4 raffinate stream into a highly reactive polyisobutylene occurs broadly through a series of steps namely:
a. Catalyst Premix Reactor for complexation of the Lewis acid & Lewis base;
b. Cationic polymerization of the C4 raffinate feed;
c. High Pressure Distillation Column to remove the unreacted monomer from the top of the column;
d. The high-pressure distillation column bottom product goes to the neutralization tank for quenching the catalyst;
e. Post neutralization, the neutralized product goes to the decanter, wherein the salt formed during neutralization goes to the aqueous tank as waste and the product goes to a divided wall distillation column; and
f. Removal of C8 oligomers and C12-C16 oligomers to obtain highly reactive polyisobutylene (HR-PIB).

Optionally the neutralized product from step e) routed to a second distillation column and a third distillation column arranged in sequence for separation of C8 oligomers, C12-C-16 oligomers, and the highly reactive polyisobutylene (HR-PIB).

The present invention also discloses an apparatus for the preparation of a highly reactive polybutene (HRPIB) with low molecular weight viz, the prepared highly reactive polybutene has an average molecular weight (Mn) ranging from 500 to 5000 Dalton and has more than 80% exo content by using lewis acid-lewis base based catalyst complex. The employed catalyst in the process is Ethylaluminum Sesquichloride (EASC). Dialkyl ether complex.

The process steps that are carried out in the apparatus includes:
a. Preparation of a homogeneous catalyst complex in a plug flow reactor (PFR), a more efficient utilization of time within the plug flow reactor (PFR), leading to longer effective residence time than a polymerization reactor, preferably a continuous stirred-tank reactor (CSTR);
b. Polymerization of isobutene (IB)/C4 raffinate in the CSTR in presence of the homogenous catalyst complex;
c. Routing unreacted isobutylene (IB) from the polymerization reactor to a high pressure distillation column for separation and recycling the unreacted isobutylene (IB) to a naphtha cracker;
d. Neutralization of the homogeneous catalyst complex in a neutralization tank with a basic media and catalyst salt separation in a decanter; and
e. Separation of C8/C12-C16 oligomers from the polymer product in a divided wall distillation column.

In an aspect of the present invention, the apparatus includes a catalyst premix reactor, a polymerization reactor, a high-pressure distillation column, a neutralization unit and two sequential distillation columns.

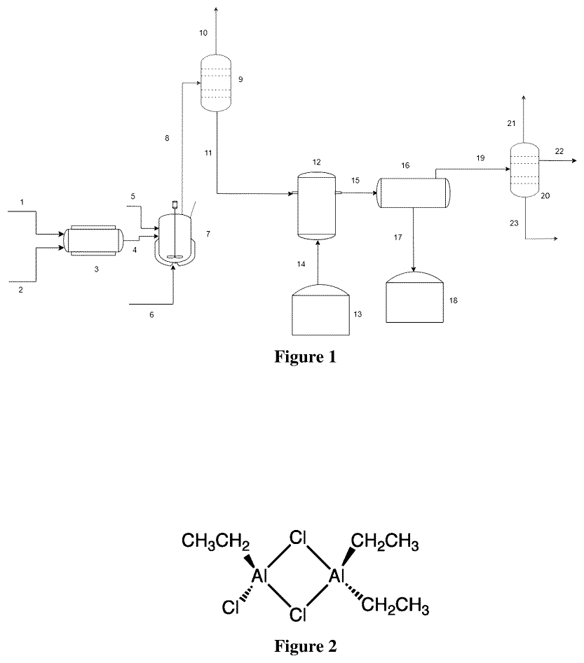

In yet another aspect of the present invention, the apparatus includes a catalyst premix reactor, a polymerization reactor, a high-pressure distillation column, a neutralization unit and a divided wall distillation (DWD) column. The schematic diagram for the apparatus with the divided wall column is shown in FIG. 1. Wherein the reference numerals are denoted as: (1) Lewis Acid, (2) Lewis Base, (3) Plug Flow Reactor (PFR), (4) Homogenous Catalyst Complex, (5) Solvent, (6) C4 Raffinate Feed, (7) Polymerization Reactor, (8) Mixture, (9) High Pressure Distillation Column, (10) Unconverted C4 Monomer to Naphtha Cracker, (11) Bottom product of High Pressure Distillation Column, (12) Neutralization Tank, (13) Polymerization Quench Tank, (14) Ammonium Hydroxide (NH₄OH) Solution, (15) Neutralized Effluent, (16) Decanter, (17) Aqueous effluents, (18) Aqueous Tank, (19) Organic effluent, (20) Divided Wall Distillation (DWD) Column, (21) C8 Oligomers, (22) C12-C16 Oligomers, (23) highly reactive polybutene (HR-PIB).

Polymerization of isobutylene (IB) also results in C8, C12, C16 and other oligomers. Thus, the disclosed/developed process of the present invention also includes a process of separating C8, and C12-C16 oligomers to control polydispersity index (PDI) of the final product i.e. the highly reactive polybutene (HRPIB) in an efficient and economical way by using a divided wall column. The advantage of employing divided wall column includes that the investment cost for preparing the highly reactive polybutene (HR-PIB) decreases by 20%-30% and operating cost decreases by around 25%. Particularly, employing the optimized process steps and separating side reaction product (i.e. C8 and C12-C16 oligomers) from the highly reactive polybutene (HRPIB) with the divided wall column, reduces an overall energy consumption of the process for preparing the highly reactive polyisobutylene (HR-PIB) up to 50%.

In an embodiment of the present invention, a process for preparing a highly reactive polyisobutylene (HRPIB), the process comprising:
i. routing a Lewis acid [1] and a Lewis base [2] in a weight percentage ratio of 1:0.8-2.5 in a catalyst premix reactor [3] for preparing a homogeneous catalyst complex [4];
ii. routing the homogeneous catalyst complex [4], a C4 raffinate feed [6] and a solvent [5] in a polymerization reactor [7] for a polymerization reaction to obtain a mixture [8] comprising the highly reactive polybutene (HR-PIB), unconverted C4 monomers, water, C8 oligomers, C12-C16 oligomers and a residual catalyst;
iii. routing the mixture [8] to a high pressure distillation column [9] for removing unconverted C4 monomers from the mixture [8] to obtain a bottom product comprising the highly reactive polybutene (HR-PIB), water, C8 oligomers, C12-C16 oligomers and the residual catalyst;
iv. routing out the unconverted C4 monomers from top of the high pressure distillation column [9] followed by recycling the unconverted C4 monomers [10] back to a naphtha cracker;
v. routing the bottom product to a neutralization tank for quenching the residual catalyst in a basic media by adding a polymerization quencher [14] routed to the neutralization tank from a polymerization quench tank [13] to obtain a neutralized effluent comprising a catalyst salt, and a product;
vi. routing the neutralized effluent to a decanter for removing water from the neutralized effluent to obtain an aqueous effluent comprising the catalyst salt, and an organic effluent comprising C8 oligomers, C12-C16 oligomers, and the highly reactive polyisobutylene (HR-PIB);
vii. routing the aqueous effluent to an aqueous tank to remove the catalyst salt;
viii. routing the organic effluent to a divided wall distillation (DWD) column [20] for removing the C8 oligomers and the C12-C16 oligomers from the organic effluent to obtain the highly reactive polyisobutylene (HR-PIB) [23]; and
ix. optionally routing the organic effluent to a second distillation column and a third distillation column arranged in a sequence for removing the C8 oligomers through atmospheric high-pressure distillation and the C12-C16 oligomers through vacuum high-pressure distillation, respectively from the organic effluent to obtain the highly reactive polyisobutylene (HR-PIB) [23].

In an embodiment of the present invention, the process for preparing highly reactive polyisobutylene (HR-PIB) comprises:
i. routing a Lewis acid [1] and a Lewis base [2] in a weight percentage ratio of 1:0.8-2.5 in a catalyst premix reactor [3] preferably a plug flow reactor (PFR) for preparing a homogeneous catalyst complex [4];
ii. routing the homogeneous catalyst complex [4], a C4 raffinate feed [6] and a solvent [5] in a polymerization reactor preferably a continuous stirred-tank reactor (CSTR) [7] for a polymerization reaction to obtain a mixture [8] comprising the highly reactive polybutene (HR-PIB), unconverted C4 monomers, water, C8 oligomers, C12-C16 oligomers and the residual catalyst;
iii. routing the mixture [8] to a high pressure distillation column [9] for removing the unconverted C4 monomers from the mixture [8] to obtain a bottom product comprising the highly reactive polybutene (HR-PIB), water, C8 oligomers, C12-C16 oligomers and the residual catalyst;
iv. routing out the unconverted C4 monomers from top of the high pressure distillation column [9] followed by recycling the unconverted C4 monomers [10] back to a naphtha cracker;
v. routing the bottom product to a neutralization tank for quenching the residual catalyst in a basic media by adding the polymerization quencher preferably an ammonium hydroxide (NH₄OH) solution routed to the neutralization tank from the polymerization quench tank to obtain a neutralized effluent comprising a catalyst salt, and a product;
vi. routing the neutralized effluent to a decanter for removing water from the neutralized effluent to obtain the aqueous effluent comprising the catalyst salt, and the organic effluent comprising C8 oligomers, C12-C16 oligomers, and the highly reactive polyisobutylene (HR-PIB); and
vii. routing the aqueous effluent to an aqueous tank to remove the catalyst salt; and
viii. routing the organic effluent to a divided wall distillation (DWD) column for removing the C8 oligomers and the C12-C16 oligomers [22] from the organic effluent for obtaining the highly reactive polyisobutylene (HR-PIB) [23].

In an embodiment of the present invention, preparing the homogenous catalyst complex [4] comprises complexing/reacting the Lewis acid [1] and the Lewis base [2] in an organic solvent at a temperature ranging from −40 to +10° C., at atmospheric pressure in presence of an initiator; wherein the initiator is water, and wherein the organic solvent selected from hexane and toluene.

In an embodiment of the present invention, the Lewis acid [1] comprises a boron halide and aluminium complexes/aluminium based bridge system; wherein the boron halide comprises BCl₃, BBr₃ and BF₃; wherein the aluminium complexes comprises AlCl₃ and MAIX₍₁₋₃₎ in which M=Et, i-Bu, and X=Cl. The Lewis base [2] comprises an ether and an alcohol; wherein the ether is selected from a group comprising methyl ether, ethyl ether, n-propyl ether, n-butyl ether, n-pentyl ether, n-hexyl ether, n-heptyl ether, n-octyl ether, sec-butyl ether, isopropyl ether, isobutyl ether, (2-ethylhexyl) ether, methyl n-butyl ether, methyl sec-butyl ether, methyl n-hexyl ether, methyl n-octyl ether, ethyl n-hexyl ether, ethyl n-octyl ether, ethyl 2-ethylhexyl ether, n-butyl n-octyl ether, n-butyl 2-ethylhexyl ether, ethyl n-butyl ether, ethyl sec-butyl ether, ethyl isobutyl ether, n-propyl-nbutyl ether, n-propyl sec-butyl ether, n-propyl isobutyl ether, n-propyl tert-butyl ether, isopropyl n-butyl ether, methyl isobutyl ether, methyl tert-butyl ether, isopropyl sec-butyl ether, isopropyl isobutyl ether, iso propyl tert-butyl ether, dicyclohexyl ether, diisopropyl ether (iPr₂O), dibutyl ether, diphenyl ether, ditolyl ether, dibenzyl ether, bis-2-chloroethyl ether, tetrahydrofuran (THF), tetrahydropyran, 1,2-dioxane, 1,3-dioxane and 1,4-dioxane; and wherein the alcohol is selected from a group comprising MeOH, EtOH, i-PrOH, and t-BuOH.

In an embodiment of the present invention, wherein the initiator is water, and wherein the organic solvent is selected from a group comprising hexane and toluene. More suitable than the chlorinated solvent and hence less water pollution while washing. Also, non-polar media is good as it is not corrosive and does not enhance the corrosion probability.

In an embodiment of the present invention, the polymerization reaction is a cationic polymerization of isobutylene in the C4 raffinate feed, wherein the homogeneous catalyst complex [4] is present in a range of 0.005-0.01 mole %.

In an embodiment of the present invention, the homogeneous catalyst complex [4] is preferably selected from an ethylaluminum sesquichloride (EASC). dialkyl ether complex, which has better solubility in the organic solvent. The chemical structure of ethyl aluminium sesquichloride (EASC) is shown in FIG. 2.

In a preferred embodiment, preparing the homogenous catalyst complex [4] comprises complexing/reacting 0.01 M aluminium complexes comprises AlCl₃ and MAIX₍₁₋₃₎ in which M=Et [ethylaluminum sesquichloride (EASC)] with 0.008-0.25 M diisopropyl ether (iPr₂O) in hexane at 0° C. under glove box.

In an embodiment of the present invention, the C4 raffinate feed [6] contains isobutylene (IB) not less than 30%. In an embodiment, the C4 raffinate feed [6] is obtained from naphtha cracking.

In an embodiment of the present invention, the polymerization quencher is selected from a group comprising methanol (CH₃OH), water, sodium hydroxide (NaOH) solution, and ammonium hydroxide (NH₄OH) solution.

In an embodiment of the present invention, the unconverted C4 monomers from the mixture obtained from step (ii) are removed and recycled back to a naphtha cracker.

This operation reduces load on subsequent unit operations.

In an embodiment of the present invention, the highly reactive polyisobutylene (HR-PIB) obtained from the process of the present invention has an exo-content of 80 to 95 mole %.

In an embodiment of the present invention, the highly reactive polyisobutylene (HR-PIB) having number average molecular weight in the range of 500-5000 Daltons, polydispersity index (PDI) in a range of 1.1-3.0 is obtained from C4 hydrocarbon compounds derived from cracking of naphtha containing not less than 30 mole % isobutylene, preferably in the range of 35 to 40 mole %.

The present invention also provides an apparatus for the preparation of highly reactive polyisobutylene (HR-PIB), the apparatus comprising:
i. a plug flow reactor (PFR) [3] for preparing a homogenous catalyst complex [4];
ii. a polymerization reactor [7] connected to the plug flow reactor [3] to receive the homogenous catalyst complex [4], along with a C4 raffinate feed [6] and a solvent [5] for a polymerization reaction to provide a mixture [8];
iii. a high pressure distillation column [9] connected to the polymerization reactor [7] to receive the mixture [8] from the polymerization reactor [7] for removing unconverted C4 monomers from the mixture [8] to obtain a bottom product [11], wherein the unconverted C4 monomers is routed out from top of the high pressure distillation column [9] and recycled back to a naphtha cracker;
iv. a neutralization tank connected to the high pressure distillation column [9] to receive the bottom product from the bottom of the high pressure distillation column [9] for neutralizing the residual catalyst in the bottom product with a polymerization quencher to obtain a neutralized effluent comprising a catalyst salt, water, C8 oligomers, C12-C16 oligomers and a highly reactive polyisobutylene (HR-PIB);
v. a polymerization quench tank connected to the neutralization tank for supplying the polymerization quencher to the neutralization tank [12];
vi. a decanter connected to the neutralization tank to receive the neutralized effluent to remove water from the neutralized effluent to obtain an aqueous effluents comprising the catalyst salt, and an organic effluent comprising C8 oligomers, C12-C16 oligomers, and the highly reactive polyisobutylene (HR-PIB);
vii. an aqueous tank connected to the decanter to receive the aqueous effluents [17]; and
viii. a divided wall distillation (DWD) column connected to the decanter to receive the organic effluent from the decanter for the removal of C8 oligomers and C12-C16 oligomers from the organic effluent to obtain the highly reactive polyisobutylene (HR-PIB) [23].

### EXAMPLES

The present disclosure with reference to the accompanying examples describes the present invention. However, those of skill in the art should, in light of the present disclosure, appreciate that many changes can be made in the specific embodiments which are disclosed and still obtain a like or similar result without departing from the spirit and scope of the invention. It is understood that the examples are provided for the purpose of illustrating the invention only and are not intended to limit the scope of the invention in any way.

### Example 1

Chain transfer cationic polymerizations were performed in a double jacketed glass reactor system equipped with chiller system, and the polymerization was conducted at 0° C. under nitrogen atmosphere. In a typical example of experiment, 400 mL of hexanes was placed in the reactor at −20° C. 200 mL of isobutylene (IB) (2 M) was condensed and added to the polymerization reactor keeping the internal temperature unchanged. Before adding the catalyst, the polymerization reactor temperature was raised to 0° C. The polymerization was started under stirring by the addition of 0.01M of EASC·iPr₂O complex to the reactors at 0° C. To make the desired hydrocarbon soluble complex, 0.01 M EASC in mixed with 0.02M iPr₂O in hexane at 0° C. under glove box. After 1 h of the polymerization, the reaction was quenched by addition of 10 mL of prechilled methanol. Finally, the solvent was evaporated and isolated yield was found to be 92 mole % (Yield was determined by gravimetric method).

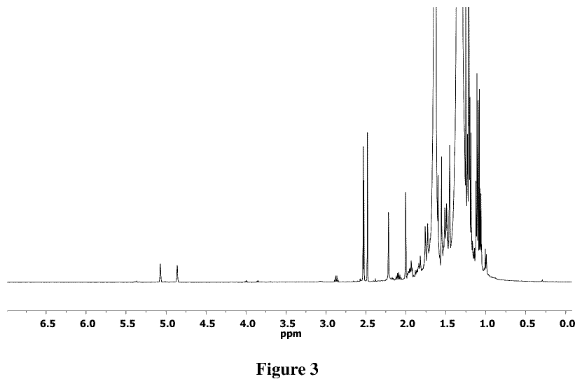

The average molecular weight of the polymer was determined by size exclusion chromatography, where THE was used as eluent and polystyrene was used as an internal standard is 1700 μm/mol. Vinylidene content was determined by 1H NMR spectroscopy as shown in FIG. 3.

### Example 2

Typically, the required amount of various C4 isomers (isobutylene, 1-butene, trans-2-butene, cis-2-butene, butadiene, other saturated C4 isomers, 2M) was placed in a double jacketed glass reactor system equipped with chiller system, and the polymerization was conducted at 0° C. under nitrogen atmosphere. the polymerization was started under stirring by the addition of 0.01M of EASC·iPr₂O complex to the reactors at 0° C. To make the desired hydrocarbon soluble complex, 0.01 M EASC in mixed with 0.008-0.25 M iPr₂O in hexane at 0° C. under glove box. After 1 h of the polymerization, the reaction was quenched by addition of 10 mL of prechilled methanol. Finally, the solvent was evaporated and isolated yield was found to be 70 mole % (Yield was determined by gravimetric method).

TABLE 1
Polymerization of IB using [Lewis acid•Lewis base] [EASC•
iPr₂O] in dry hexanes at 0° C.

| | | | Conv. | | | |
|---|---|---|---|---|---|---|
| | [EASC] | [iPr₂O] | (weight | | M_{n, GPC}, | Exo |
| Entry | (M) | (M) | %)^{a} | M_{n, NMR} | PDI | (%)^{b} |
| 1 | 0.01 | | 98 | 5600 | 5800 | ~1 |
| 2 | 0.01 | 0.008 | 92 | 4000 | 4100 | 65 |
| 3 | 0.01 | 0.01 | 90 | 2100 | 2200 | 67 |
| 4 | 0.01 | 0.015 | 87 | 2200 | 2300 | 69 |
| 5 | 0.01 | 0.02 | 86 | 1800 | 1700 | 80 |
| 6 | 0.01 | 0.025 | 82 | 1400 | 1300 | 85 |

^{a}Determined by gravimetric method.
^{b}Determined from 1H NMR.

From the process by employing a pure isobutylene (IB) feed, a yield of 90-95 weight % of highly reactive polyisobutylene (HR-PIB) with a vinylidene content of ~>80 mole % was achieved whereas by employing a C4 raffinate feed, the vinylidene content reached in a range of 70-85 mole % with a yield of 90-98 weight % of highly reactive polyisobutylene (HR-PIB).

We claim:

1. A process for preparing a highly reactive polyisobutylene (HRPIB), the process comprising:
i. routing a Lewis acid [1] and a Lewis base [2] in a weight percentage ratio of 1:0.8-2.5 in a catalyst premix reactor [3] for preparing a homogeneous catalyst complex [4];
ii. routing the homogeneous catalyst complex [4], a C4 raffinate feed [6] and a solvent [5] in a polymerization reactor [7] for a polymerization reaction to obtain a mixture [8] comprising the highly reactive polyisobutylene (HR-PIB), unconverted C4 monomers, water, C8 oligomers, C12-C16 oligomers and a residual catalyst;
iii. routing the mixture [8] to a high pressure distillation column [9] for removing unconverted C4 monomers from the mixture [8] to obtain a bottom product comprising the highly reactive polyisobutylene (HR-PIB), water, C8 oligomers, C12-C16 oligomers and the residual catalyst;
iv. routing out the unconverted C4 monomers from top of the high pressure distillation column [9] followed by recycling the unconverted C4 monomers back to a naphtha cracker;
v. routing the bottom product to a neutralization tank for quenching the residual catalyst in a basic media by adding a polymerization quencher routed to the neutralization tank from a polymerization quench tank to obtain a neutralized effluent comprising a catalyst salt, and a product;
vi. routing the neutralized effluent to a decanter for removing water from the neutralized effluent to obtain an aqueous effluent comprising the catalyst salt, and an organic effluent comprising C8 oligomers, C12-C16 oligomers, and the highly reactive polyisobutylene (HR-PIB);
vii. routing the organic effluent to a divided wall distillation (DWD) column for removing the C8 oligomers and the C12-C16 oligomers from the organic effluent to obtain the highly reactive polyisobutylene (HR-PIB) [23]; and
viii. optionally routing the organic effluent to a second distillation column and a third distillation column arranged in a sequence for removing the C8 oligomers through atmospheric high-pressure distillation and the C12-C16 oligomers through vacuum high-pressure distillation, respectively from the organic effluent to obtain the highly reactive polyisobutylene (HR-PIB) [23].

2. The process as claimed in claim 1, wherein the process for preparing highly reactive polyisobutylene (HR-PIB) comprises:
i. routing a Lewis acid [1] and a Lewis base [2] in a weight percentage ratio of 1:0.8-2.5 in a catalyst premix reactor [3] preferably a plug flow reactor (PFR) for preparing a homogeneous catalyst complex [4];
ii. routing the homogeneous catalyst complex [4], a C4 raffinate feed [6] and a solvent [5] in a polymerization reactor preferably a continuous stirred-tank reactor (CSTR) [7] for a polymerization reaction to obtain a mixture [8] comprising the highly reactive polyisobutylene (HR-PIB), unconverted C4 monomers, water, C8 oligomers, C12-C16 oligomers and the residual catalyst;
iii. routing the mixture [8] to a high pressure distillation column [9] for removing the unconverted C4 monomers from the mixture [8] to obtain a bottom product comprising the highly reactive polyisobutylene (HR-PIB), water, C8 oligomers, C12-C16 oligomers and the residual catalyst;
iv. routing out the unconverted C4 monomers from top of the high pressure distillation column [9] followed by recycling the unconverted C4 monomers back to a naphtha cracker;
v. routing the bottom product to a neutralization tank for quenching the residual catalyst in a basic media by adding the polymerization quencher preferably an ammonium hydroxide (NH₄OH) solution routed to the neutralization tank from the polymerization quench tank to obtain a neutralized effluent comprising a catalyst salt, and a product;
vi. routing the neutralized effluent to a decanter for removing water from the neutralized effluent to obtain an aqueous effluent comprising a catalyst salt, and an organic effluent comprising C8 oligomers, C12-C16 oligomers, and the highly reactive polyisobutylene (HR-PIB);
vii. routing the aqueous effluent to an aqueous tank to remove the catalyst salt; and
viii. routing the organic effluent to a divided wall distillation (DWD) column for removing the C8 oligomers and the C12-C16 oligomers from the organic effluent for obtaining the highly reactive polyisobutylene (HRPIB) [23].

3. The process as claimed in claim 1, wherein preparing the homogenous catalyst complex [4] comprises complexing/reacting the Lewis acid [1] and the Lewis base [2] in an organic solvent at a temperature ranging from −40 to +10° C., at atmospheric pressure in presence of an initiator; wherein the initiator is water, and wherein the organic solvent selected from hexane and toluene.

4. The process as claimed in claim 1, wherein the Lewis acid [1] comprises a boron halide and aluminium complexes; wherein the boron halide is selected from BCl₃, BBr₃ and BF₃; wherein the aluminium complexes are selected from AlCl₃ and MAIX₍₁₋₃₎ wherein M=Et, i-Bu, and X=Cl; wherein the Lewis base [2] is selected from an ether and an alcohol; wherein the ether is selected from a group comprising methyl ether, ethyl ether, n-propyl ether, n-butyl ether, n-pentyl ether, n-hexyl ether, n-heptyl ether, n-octyl ether, sec-butyl ether, isopropyl ether, isobutyl ether, (2-ethylhexyl) ether, methyl n-butyl ether, methyl sec-butyl ether, methyl n-hexyl ether, methyl n-octyl ether, ethyl n-hexyl ether, ethyl n-octyl ether, ethyl 2-ethylhexyl ether, n-butyl n-octyl ether, n-butyl 2-ethylhexyl ether, ethyl n-butyl ether, ethyl sec-butyl ether, ethyl isobutyl ether, n-propyl-nbutyl ether, n-propyl sec-butyl ether, n-propyl isobutyl ether, n-propyl tert-butyl ether, isopropyl n-butyl ether, methyl isobutyl ether, methyl tert-butyl ether, isopropyl sec-butyl ether, isopropyl isobutyl ether, iso propyl tert-butyl ether, dicyclohexyl ether, diisopropyl ether (iPr₂O), dibutyl ether, diphenyl ether, ditolyl ether, dibenzyl ether, bis-2-chloro ethyl ether, tetrahydrofuran (THF), tetrahydropyran, 1,2-dioxane, 1,3-dioxane and 1,4-dioxane, and wherein the alcohol is selected from a group comprising MeOH, EtOH, i-PrOH, and t-BuOH.

5. The process as claimed in claim 3, wherein preparing the homogenous catalyst complex [4] comprises complexing/reacting 0.01 M aluminium complexes comprises AlCl₃ and MAIX₍₁₋₃₎ in which M=Et [ethylaluminum sesquichloride (EASC)] with 0.008 to 0.25 M diisopropyl ether (iPr₂O) in hexane at 0° C. under glove box.

6. The process as claimed in claim 1, wherein the polymerization reaction is a cationic polymerization of isobutylene (IB) in the C4 raffinate feed [6], wherein the homogeneous catalyst complex [4] is present in a range of 0.005-0.01 mole %; wherein the homogeneous catalyst complex [4] is preferably selected from an ethylaluminum sesquichloride (EASC). dialkyl ether complex.

7. The process as claimed in claim 1, wherein the C4 raffinate feed [6] comprises an isobutylene content not less than 30 wt. %, preferably in the range of 35 to 40%.

8. The process as claimed in claim 1, wherein the polymerization quencher is selected from a group comprising methanol (CH₃OH), water, sodium hydroxide (NaOH) solution, and ammonium hydroxide (NH₄OH) solution.

9. The process as claimed in claim 1, wherein the highly reactive polyisobutylene (HR-PIB) obtained from the process has an exo-content of 80 to 90 mole %, and wherein the highly reactive polyisobutylene (HR-PIB) is having number an average molecular weight in a range of 500-5000 Daltons, and a polydispersity index (PDI) in a range of 1.1-3.0.

10. An apparatus for preparing a highly reactive polyisobutylene (HR-PIB), the apparatus comprising:
i. a plug flow reactor (PFR) [3] for preparing a homogenous catalyst complex [4];
ii. a polymerization reactor [7] connected to the plug flow reactor [3] to receive the homogenous catalyst complex [4], along with a C4 raffinate feed [6] and a solvent [5] for a polymerization reaction to provide a mixture [8];
iii. a high pressure distillation column [9] connected to the polymerization reactor [7] to receive the mixture [8] from the polymerization reactor [7] for removing unconverted C4 monomers from the mixture [8] to obtain a bottom product [11], wherein the unconverted C4 monomers is routed out from top of the high pressure distillation column [9] and recycled back to a naphtha cracker;
iv. a neutralization tank connected to the high pressure distillation column [9] to receive the bottom product from the bottom of the high pressure distillation column [9] for neutralizing the residual catalyst in the bottom product with a polymerization quencher to obtain a neutralized effluent comprising a catalyst salt, water, C8 oligomers, C12-C16 oligomers and a highly reactive polyisobutylene (HR-PIB);
v. a polymerization quench tank connected to the neutralization tank for supplying the polymerization quencher to the neutralization tank [12];
vi. a decanter connected to the neutralization tank to receive the neutralized effluent to remove water from the neutralized effluent to obtain an aqueous effluents comprising the catalyst salt, and an organic effluent comprising C8 oligomers, C12-C16 oligomers, and the highly reactive polyisobutylene (HR-PIB);
vii. an aqueous tank connected to the decanter to receive the aqueous effluents [17]; and
viii. a divided wall distillation (DWD) column connected to the decanter to receive the organic effluent from the decanter for the removal of C8 oligomers and C12-C16 oligomers from the organic effluent to obtain the highly reactive polyisobutylene (HR-PIB) [23].
